(19) United States
(12) Patent Application Publication
(10) Pub. No.: US 2012/0298269 A1
(43) Pub. Date: Nov. 29, 2012

(54) COMMERCIAL TRUCK TIRE

(76) Inventors: Vincent Benoit Mathonet, Habay la Neuve (BE); Christophe Henri Joseph Schyns, Rossart (BE); Phuoc Thuan Le, Attert (BE)

(21) Appl. No.: 13/116,350

(22) Filed: May 26, 2011

(51) Int. Cl. B60C 11/01

(52) U.S. Cl. 152/209.16

(57) ABSTRACT

A tire includes a circumferential regional tire tread having a central region and first and second shoulder regions adjacent the central region. A circumferential array of spaced apart shoulder sipes is formed within one or both of the shoulder regions, each of the shoulder sipes having a depth in an unworn tire tread condition within a depth range of from 1 mm to 3.5 mm, and each shoulder sipe having a longitudinal axis oriented in a substantially axial direction within a range of between 20 degrees of the tire axial direction. The shoulder sipes each include a first and a second straight segment intersecting at an end-to-end intersection with respect to each other at an intersection angle. The first and second straight segments of each shoulder sipe incline in opposite directions from the end-to-end intersection and the end-to-end intersection of each shoulder sipe is located at a circumferential shoulder groove within a respective shoulder region.

### FIELD OF THE INVENTION

The invention relates generally to regional tires for commercial trucks and, more specifically, to a tread configuration for tires intended for slippery or even winter driving conditions.

### BACKGROUND OF THE INVENTION

Commercial truck regional tires constructed for slippery or even winter driving conditions are intended to be suitable for running on surfaces of reduced compactness such as snow-covered roadways. Such tires are required to demonstrate suitable traction (gripping), power, braking, and handling characteristics on wet or snow covered surfaces while maintaining rolling resistance and mileage performance. The tread pattern of commercial truck regional tires must accordingly meet such competing objectives in order to provide the user with acceptable tire performance.

### SUMMARY OF THE INVENTION

In one aspect of the invention, a tire includes a circumferential tire tread having a central region and first and second shoulder regions adjacent the central region A circumferential array of spaced apart shoulder sipes is formed within one or both of the shoulder regions, each of the shoulder sipes having a depth in an unworn tire tread condition within a depth range of from 1 mm to 3.5 mm, and each shoulder sipe having a longitudinal axis oriented in an axial direction within a range of between 20 degrees of the tire axial direction.

In another aspect, the shoulder sipes extend in an axial direction and exclusively reside in one or both of the shoulder region(s) of the tire tread. The shoulder sipes each include a first and a second straight segment intersecting at an end-to-end intersection with respect to each other at an intersection angle. The first and second straight segments of each shoulder sipe incline in opposite directions from the end-to-end intersection and the end-to-end intersection of each shoulder sipe is located at a circumferential shoulder groove within a respective shoulder region.

### DEFINITIONS

“Aspect ratio” of the tire means the ratio of its section height (SH) to its section width (SW) multiplied by 100 percent for expression as a percentage.

“Asymmetric tread” means a tread that has a tread pattern not symmetrical about the center plane or equatorial plane EP of the tire.

“Axial” and “axially” means lines or directions that are parallel to the axis of rotation of the tire.

“Chafer” is a narrow strip of material placed around the outside of a tire bead to protect the cord plies from wearing and cutting against the rim and distribute the flexing above the rim.

“Circumferential” means lines or directions extending along the perimeter of the surface of the annular tread perpendicular to the axial direction.

“Equatorial Centerplane (CP)” means the plane perpendicular to the tire's axis of rotation and passing through the center of the tread.

“Footprint” means the contact patch or area of contact of the tire tread with a flat surface at zero speed and under normal load and pressure.

“Groove” means an elongated void area in a tread that may extend circumferentially or laterally about the tread in a straight, curved, or zigzag manner. Circumferentially and laterally extending grooves sometimes have common portions. The “groove width” is equal to tread surface area occupied by a groove or groove portion, the width of which is in question, divided by the length of such groove or groove portion; thus, the groove width is its average width over its length. Grooves may be of varying depths in a tire. The depth of a groove may vary around the circumference of the tread, or the depth of one groove may be constant but vary from the depth of another groove in the tire. If such narrow or wide grooves are substantially reduced depth as compared to wide circumferential grooves which the interconnect, they are regarded as forming “tie bars” tending to maintain a rib-like character in tread region involved.

“Inboard side” means the side of the tire nearest the vehicle when the tire is mounted on a wheel and the wheel is mounted on the vehicle.

“Lateral” means an axial direction.

“Lateral edges” means a line tangent to the axially outermost tread contact patch or footprint as measured under normal load and tire inflation, the lines being parallel to the equatorial centerplane.

“Net contact area” means the total area of ground contacting tread elements between the lateral edges around the entire circumference of the tread divided by the gross area of the entire tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Outboard side” means the side of the tire farthest away from the vehicle when the tire is mounted on a wheel and the wheel is mounted on the vehicle.

“Radial” and “radially” means directions radially toward or away from the axis of rotation of the tire.

“Rib” means a circumferentially extending strip of rubber on the tread which is defined by at least one circumferential groove and either a second such groove or a lateral edge, the strip being laterally undivided by full-depth grooves.

“Sipe” means small slots molded into the tread elements of the tire that subdivide the tread surface and improve traction, sipes are generally narrow in width and close in the tires footprint as opposed to grooves that remain open in the tire's footprint.

“Tread element” or “traction element” means a rib or a block element defined by having a shape adjacent grooves.

“Tread Arc Width” means the arc length of the tread as measured between the lateral edges of the tread.

### BRIEF DESCRIPTION OF THE DRAWINGS

The invention will be described by way of example and with reference to the accompanying drawings in which:

FIG. 1 is an isometric view of a tire having a tire tread configured according to the invention.

FIG. 2 is a front plan view thereof.

FIG. 3 is an enlarged view of a portion of the tread taken from FIG. 2.

FIG. 4 is an enlarged fragmented front view taken from FIG. 2.

FIG. 5 is a barrel shaped foot print of the tire tread.

### DETAILED DESCRIPTION OF THE INVENTION

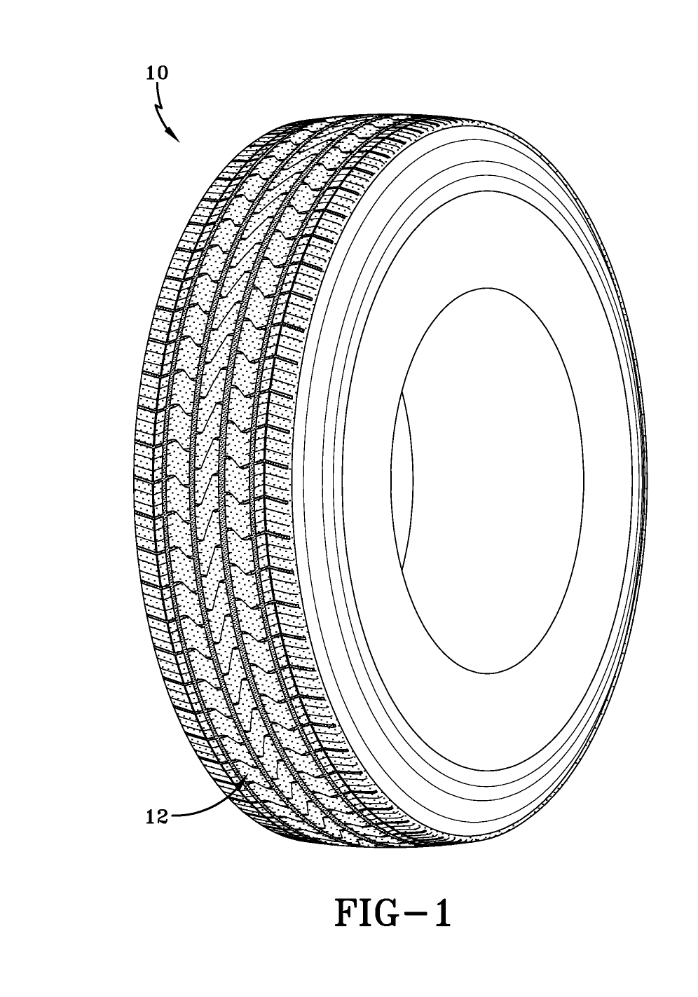

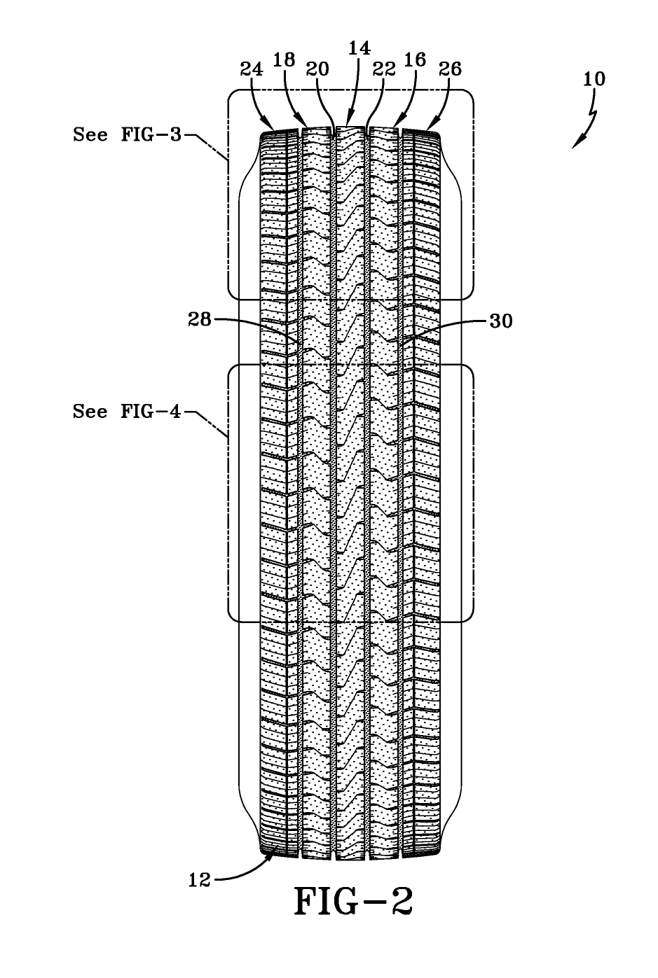

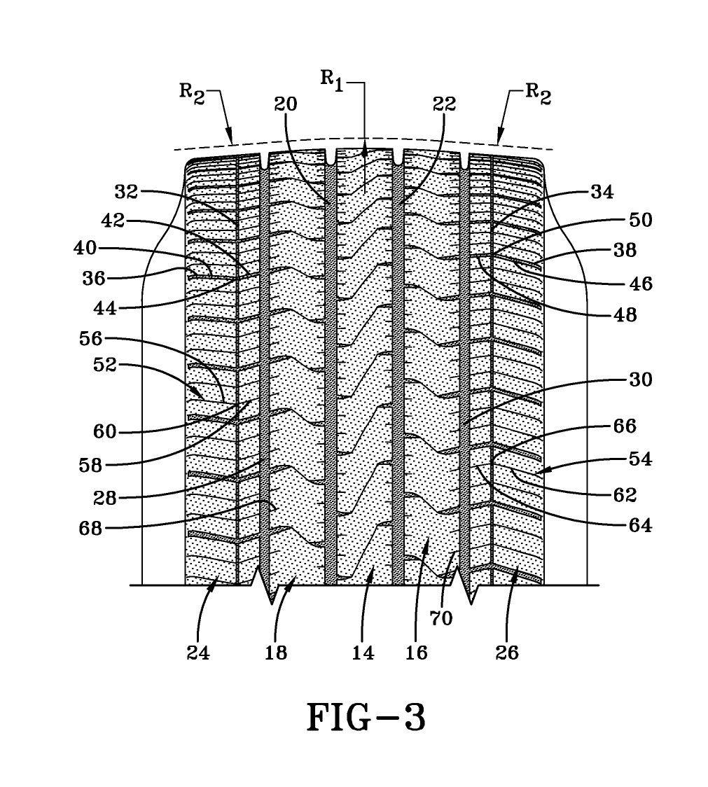

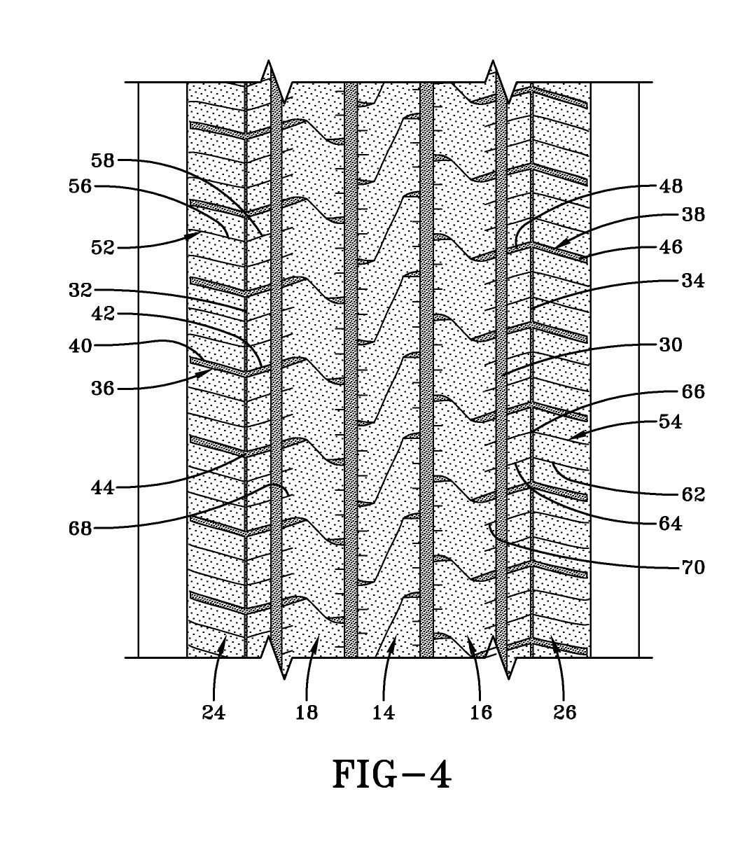

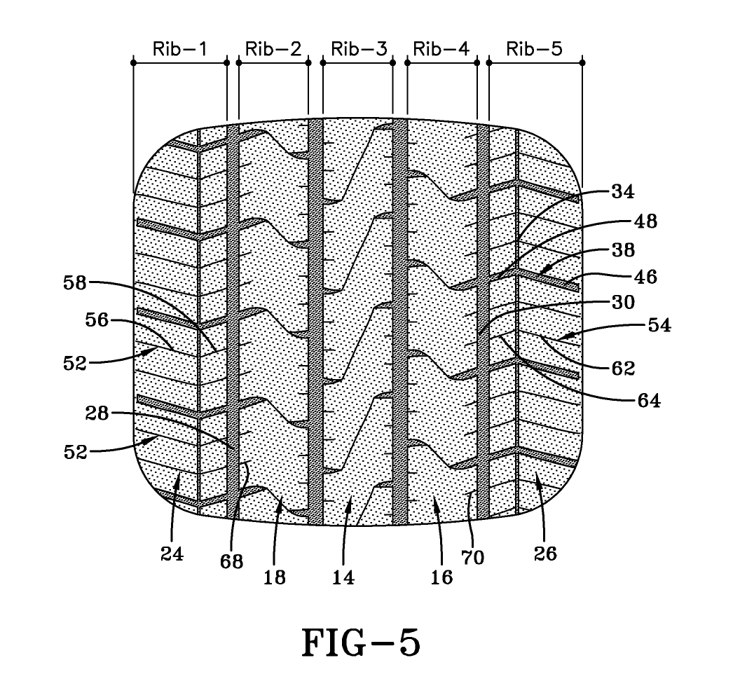

With reference to FIGS. 1 through 5, a tire 10 is constructed having a circumferential tread 12 including a center tread rib 14, a pair of intermediate ribs 16, 18 on opposite respective sides of the center rib 14 and separated from the center rib by respective circumferential grooves 20, 22. A pair of shoulder tread regions 24, 26 are positioned on opposite sides of the tread, each separated from a respective intermediate rib by a shoulder groove 28, 30. Each of the shoulder regions 24, 26 has a circumferential narrow groove 32, 34 that is proximally located to a respective groove 28, 30.

A circumferential array of spaced apart groove fingers 36, 38 extend laterally inward from opposite edges of the tread 12 across a respective shoulder region 24, 26. The lateral groove fingers 36 of the shoulder region 24 include generally straight groove segments 40, 42 that incline at an angle in opposite directions and intersect end to end at an intersection 44. The circumferential array of spaced apart groove fingers 38 of the opposite shoulder region 26 are likewise constructed having inclined straight groove segments 46, 48 angled to incline in opposite directions and intersecting at an intersection 50. The groove fingers 36, 38 generally incline in opposite respective directions and the intersections 44, 50 of groove segments in each shoulder region are in a preferred position along the narrow circumferential grooves 32, 34, respectively.

Each shoulder region 24, 26 is further constructed having a circumferential array of spaced apart lateral sipes 52, 54 The lateral sipes 52, 54 of the shoulder regions 24, 26 include generally straight sipe segments 56, 58 and 62, 64, respectively, that incline at an angle in opposite directions and intersect end to end at intersections 60,66, respectively. The sipes 52, 54 generally incline in opposite respective directions and the intersections 60, 66 of the sipes 52, 54 are in a preferred position along the narrow circumferential grooves 32, 34, respectively. Each of the sipes 52, 54 has an inward end portion 68, 70 that crosses a respective groove 32, 34 and terminates within an intermediate rib 16, 18, respectively.

It will be apparent from FIGS. 1 through 5 that the lateral siping 52, 54 resides exclusively in the shoulder regions 24, 26 in the preferred tread shown. The depth of such sipes is in a range of from 1-3.5 mm, with a preferred depth of 2-3 mm. Moreover, both of the shoulder regions 24, 26 include the array of sipes 52, 54.

The tread 12 provides a beneficial performance in a commercial vehicle, particularly in a truck steer tire. The sipes 52, 54 are configured from generally less than five straight segments such as the two segment embodiments shown. The sipes are disposed having ends 68, 70 which extend across the circumferential grooves 28, 30. In the tread 12, five (shown) or six (not shown) circumferential ribs may be deployed. Each of the sipes 52, 54 within the shoulder regions is configured from two straight parts inclined with respect to each other so as to form an intersection 60, 66, preferably at the location of the circumferential narrow grooves 32, 34. The sipes extend substantially in a lateral or axial direction at an angle in a range of ±20 degrees of the axial direction. The sipes 52 of the shoulder region 24 are angled and inclined in an opposite direction from the sipes 54 in the opposite shoulder region 26 and maintain a preferred constant depth of 2-3 mm along the entirety of the sipe length when the tire tread is new. The sipes 52, 54 residence within the shoulder regions 24, 26 have a preferred depth of less than 3 mm. Such sipes improve the steering response of the tire if used as a commercial truck steer tire. The shoulder footprint area increases drastically when cornering. This tread part plays an important role during a cornering maneuver. The presence of biting edges in that region induces vibrations when cornering/slipping that informs the driver about the tire adherence. Deeper siping greater than 3 mm creates a risk that the sipes become the source of tread cracks or irregular wear issues such as heel and toe wear.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A tire comprising:
a circumferential tire tread comprising:
a central region and first and second shoulder regions adjacent the central region;
at least one of the shoulder regions having a circumferential array of spaced apart shoulder sipes, each of the shoulder sipes having a depth in an unworn tire tread condition within a depth range of from 1 mm to 3.5 mm, and each shoulder sipe having a longitudinal axis oriented in a substantially axial direction within a range of between 20 degrees of the tire axial direction.

2. The tire of claim 1, wherein the shoulder sipes extend substantially in an axial direction and reside exclusively within at least one shoulder region of the tire tread.

3. The tire of claim 2, wherein the shoulder sipes reside exclusively within both the first and the second shoulder regions.

4. The tire of claim 3, wherein the shoulder sipes each comprise a plurality of end-to-end straight sipe segments.

5. The tire of claim 4, wherein the number of straight sipe segments within each shoulder sipe is less than five.

6. The tire of claim 5, wherein each shoulder sipe extends across a circumferential shoulder groove within a respective shoulder region.

7. The tire of claim 6, wherein the tire tread comprises five or six circumferential ribs, adjacent ribs separated by a circumferential groove.

8. The tire of claim 6, wherein each shoulder sipe has at least a first and a second straight segment intersecting at an end-to-end intersection with respect to each other at an intersection angle.

9. The tire of claim 8, wherein the first and second straight segments of each shoulder sipe incline in opposite directions from the end-to-end intersection.

10. The tire of claim 9, wherein the end-to-end intersection of each shoulder sipe is located at the circumferential shoulder groove.

11. The tire of claim 10, wherein the shoulder sipes of the first shoulder region are inclined in an opposite direction than the shoulder sipes in the second shoulder region.

12. A tire comprising:
a circumferential tire tread comprising:
a central region and first and second shoulder regions adjacent the central region;
at least one of the shoulder regions having a circumferential array of spaced apart shoulder sipes, each of the shoulder sipes having a depth in an unworn tire tread condition within a depth range of from 1 mm to 3.5 mm, and each shoulder sipe having a longitudinal axis oriented in a substantially axial direction within a range of between 20 degrees of the tire axial direction;
wherein the shoulder sipes extend substantially in an axial direction and reside exclusively within both the first and the second shoulder regions of the tire tread; and each shoulder sipe comprises at least a first and a second straight segment intersecting at an end-to-end intersection with respect to each other at an intersection angle, wherein the first and second straight segments of each shoulder sipe incline in opposite directions from the end-to-end intersection and the end-to-end intersection of each shoulder sipe is located at the circumferential shoulder groove.
